(19) United States
(12) Patent Application Publication
(10) Pub. No.: US 2013/0194291 A1
(43) Pub. Date: Aug. 1, 2013

(54) IMAGE PROCESSING APPARATUS, IMAGE PROCESSING METHOD, IMAGE PROCESSING SYSTEM, AND RECORDING MEDIUM

(71) Applicant: Takayuki HIROTANI, Akiruno-shi (JP)

(72) Inventor: Takayuki HIROTANI, Akiruno-shi (JP)

(73) Assignee: CASIO COMPUTER COl., LTD, Tokoyo (JP)

(21) Appl. No.: 13/432,445

(22) Filed: Mar. 28, 2012

(30) Foreign Application Priority Data
Jan. 30, 2012 (JP) 2012-017061

(51) Int. Cl. G09G 5/39; G09G 5/02

(52) U.S. Cl. 345/589; 345/531

(57) ABSTRACT

An image processing apparatus includes a storage which stores a transformed image and attribute information indicating a content of the image transformation, a display controller which reads and displays the transformed image stored in the storage, a processor which processes an image in an arbitrary portion in the image displayed by the display controller, and an image update module which updates the image in the portion, which is processed by the processor, according to the attribute information stored in the storage.

### CROSS-REFERENCE TO RELATED APPLICATIONS

This application is based upon and claims the benefit of priority from prior Japanese Patent Application No. 2012-017061, filed Jan. 30, 2012, the entire contents of which are incorporated herein by reference.

### BACKGROUND OF THE INVENTION

1. Field of the Invention

The present invention relates to an image processing apparatus that transforms a captured image, an image processing method, an image processing system, and a computer readable storage medium.

2. Description of the Related Art

Edit and process are easily performed in digital data of an image. For example, digital data of a captured image can be edited and processed by utilizing a commercially available application program. Further, a digital camera includes a function of editing and processing a captured image.

Conventionally there are various technologies for editing and processing the image. For example, the image can be transformed into a painting-style image by performing predetermined image transformation to the image data (see Jpn Pat. Appln. KOKAI No. 2006-031688). A stylized graphic such as a straight line and a circle or a different image can be added to the transformed image, and a handwritten character or graphic can be written in the transformed image by utilizing a pointing device.

However, when the character or the graphic is touched up on the transformed image to which the image transformation is already performed, or when another image is added to the transformed image, unfortunately the touched-up portion or the additional image does not fit in the transformed image to partially generate a feeling of strangeness.

### BRIEF SUMMARY OF THE INVENTION

The invention has been made considering the above circumstances, and an object of the invention is to provide an image processing apparatus that can reduce the feeling of strangeness as much as possible when the process such as the touch-up and the addition is performed to the transformed image to which the image transformation is already performed, an image processing method, an image processing system, and a computer readable storage medium.

According to an embodiment of the present invention, an image processing apparatus includes a storage configured to store a transformed image and attribute information indicating a content of the image transformation; a display controller configured to read and to display the transformed image stored in the storage; a processor configured to process an image in an arbitrary portion in the image displayed by the display controller; and an image update module configured to update the image in the portion, which is processed by the processor, according to the attribute information stored in the storage.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL, VIEWS OF THE DRAWINGS

The accompanying drawings, which are incorporated in and constitute a part of the specification, illustrate embodiments of the present invention and, together with the general description given above and the detailed description of the embodiments given below, serve to explain the principles of the present invention.

FIG. 1 is a block diagram illustrating a configuration of an image processing apparatus according to an embodiment of the invention.

FIG. 2 is a flowchart illustrating contents of image transformation of the embodiment.

FIG. 3 is a view illustrating a pre-transformation image displayed on a display of the embodiment.

FIG. 4 is a view illustrating a transformed image displayed on the display of the embodiment.

FIG. 5 is a view illustrating a touch-up image displayed on the display of the embodiment.

FIG. 6 is a view illustrating an image displayed on a display of the embodiment after a touched-up portion is transformed.

FIG. 7 is a flowchart illustrating contents of another example of image transformation of the embodiment.

FIG. 8 is a view illustrating an image displayed on a display of the embodiment when a signature is touched up.

FIG. 9 is a view illustrating an image displayed on a display of the embodiment after the touch-up signature is transformed.

FIG. 10 is a view illustrating an image displayed on a display of the embodiment when another image is added.

FIG. 11 is a view illustrating an image displayed on a display of the embodiment after another added image is transformed.

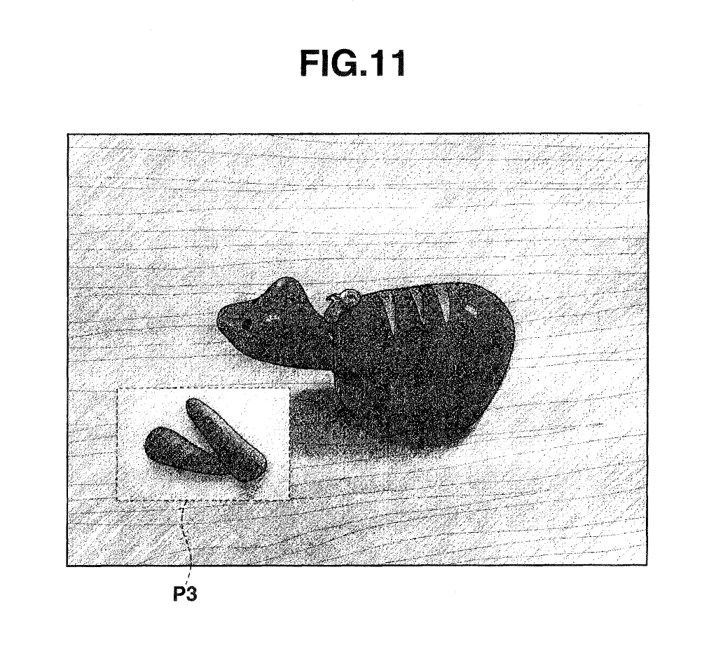

FIG. 12 is a block diagram illustrating a configuration of another system of the embodiment.

FIG. 13 is a functional block diagram illustrating an image transformation in the system configuration in FIG. 11 of the embodiment.

FIG. 14 is a functional block diagram illustrating an image transformation that is of a modification in the system configuration in FIG. 11 of the embodiment.

FIG. 15 is a functional block diagram illustrating an image transformation that is of another modification in the system configuration in FIG. 11 of the embodiment.

### DETAILED DESCRIPTION OF THE INVENTION

Hereinafter, an image processing apparatus according to an embodiment of the invention will be described with reference to the drawings.

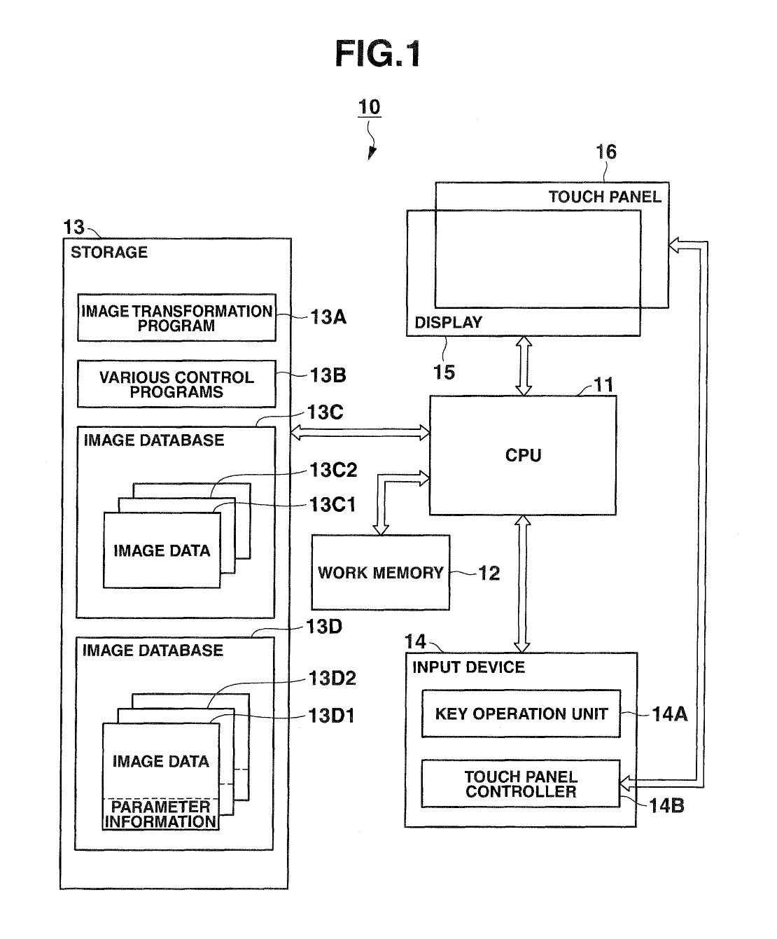

FIG. 1 is a block diagram illustrating a circuit configuration of an image processing apparatus 10 of the embodiment. The image processing apparatus 10 includes a CPU 11, a work memory 12, a storage 13, an input device 14, a display 15, and a touch panel 16.

The CPU 11 controls a whole operation of the image processing apparatus 10. The CPU 11 reads application programs including an image transformation program (described below) from the storage 13, and sequentially performs the application programs after storing the application programs on the work memory 12.

For example, the storage 13 is constructed by a Hard Disk Drive (HDD) and a Solid State Drive (SSD) such as a flash memory, in which program and data are stored in a nonvolatile manner. Examples of contents stored in the storage 13 includes an image transformation program 13A, various control programs 13B, an image database (DB) 13C, and a transformed image database (DB) 13D.

The image transformation program 13A is used to perform an image transformation to a whole or part of image data (described below).

The various control programs 13B except the image transformation program 13A are executed by the CPU 11.

Original pieces of image data 13C1, 13C2, . . . , to which the image transformation is not performed yet, are stored in the image database 13. For example, the original pieces of image data 13C1, 13C2, . . . are compressed by a JPEG (Joint Photographic Experts Group) method.

The transformed image database 13D includes pieces of transformed image data to which the image transformation is performed, for example, pieces of transformed image data 13D1, 13D2, . . . that are compressed by the JPEG method. Parameter information, which is used in the image transformation and indicates an image transformation type, is associated with each piece of transformed image data constituting the transformed image database 13D.

The input device 14 includes a key operation unit 14A that includes a keyboard and a controller of the keyboard and a touch panel controller 14B. The input device 14 receives any input of a user.

For example, the display 15 includes a backlight color TFT (Thin Film Transistor) liquid crystal panel and a drive circuit of the liquid crystal panel. The display 15 displays pieces of data such as various images. The touch panel 16 constructed by a transparent electrode panel is integrally formed on the display 15. When the user performs a touch input operation or a drawing operation on the touch panel 16 using a user's finger or a dedicated stylus pen (not illustrated), the touch panel 16 detects information on a corresponding coordinate value sequence, and outputs the information to the touch panel controller 14B of the input device 14. The touch panel controller 14B detects an operation position of the user from the coordinate value sequence detected by the touch panel 16, and transmits the operation position to the CPU 11.

As needed basis, the CPU 11 causes the display 15 to display handwriting and the like according to the user operation position on the touch panel 16, which is transmitted from the touch panel controller 14B of the input device 14.

An operation of the embodiment will be described.

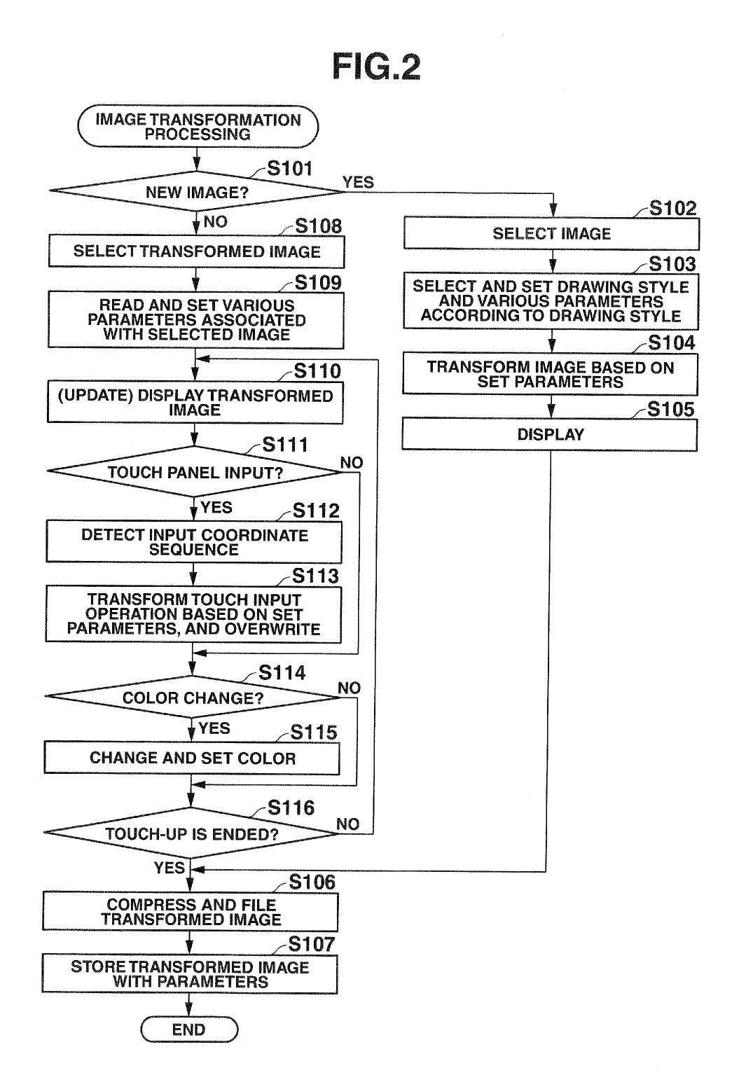

FIG. 2 is a flowchart illustrating contents of image transformation of the embodiment. In FIG. 2, the CPU 11 reads the image transformation program 13A stored in the storage 13, and sequentially executes the image transformation program 13A after storing the image transformation program 13A in the work memory 12.

At the beginning of the processing, according to a selection operation of the user, the CPU 11 determines whether the image transformation is newly performed to the original image data to which the image transformation is not performed yet or correction or touch-up is performed to the image data to which the image transformation is already performed (step S101).

When the user performs the selection operation that the image transformation is newly performed to the original image data, the CPU 11 determines the selection operation that the image transformation is newly performed to the original image data, and encourages the user to set one of the pieces of original image data, which is stored in the image database 13C of the storage 13 while the image transformation is not performed yet.

For example, the CPU 11 reads thumbnail images or pieces of data of resized images of the original pieces of image data 13C1, 13C2, . . . stored in the image database 13C, displays a list of the thumbnail images or pieces of data of resized images, and receives the user operation to select one of the original pieces of image data 13C1, 13C2, . . . from the touch panel 16 or the key operation unit 14A (step S102).

At this point, as needed basis, the CPU 11 may perform display control such that the user can check the contents of the images by enlarging only the temporarily-selected image using the whole or most part of the display 15.

When the image is selected, the CPU 11 encourages the user to select a drawing style (or tone) of the image transformation, receives various parameters necessary for the drawing style and input contents, and sets the selected contents (step S103).

The parameters are classified into a parameter that is previously set according to each drawing style (each tone) and a parameter, such as an image size assignment and a transformation intensity assignment, which is assigned by the user. Proper contents of the previously-set parameter depend on an image size even if the image transformation is performed to the same original image by the same drawing style.

For example, it is assumed that the selectable drawing style of the tone includes 12 types, namely, oil painting, impasto, gothic oil painting, fauvist oil painting, watercolor, gouache, pastel, color pencil, pointillism, silk screen, drawing, and airbrush.

The selectable drawing style also includes processing called an HDR (High Dynamic Range). In the HDR, a photograph having a wide dynamic range that cannot be expressed by a normal photograph is taken in a narrow dynamic range width by tone mapping, whereby a blown cut highlight caused by overexposure or a blocked up shadow caused by underexposure is corrected to enhance an expressive power.

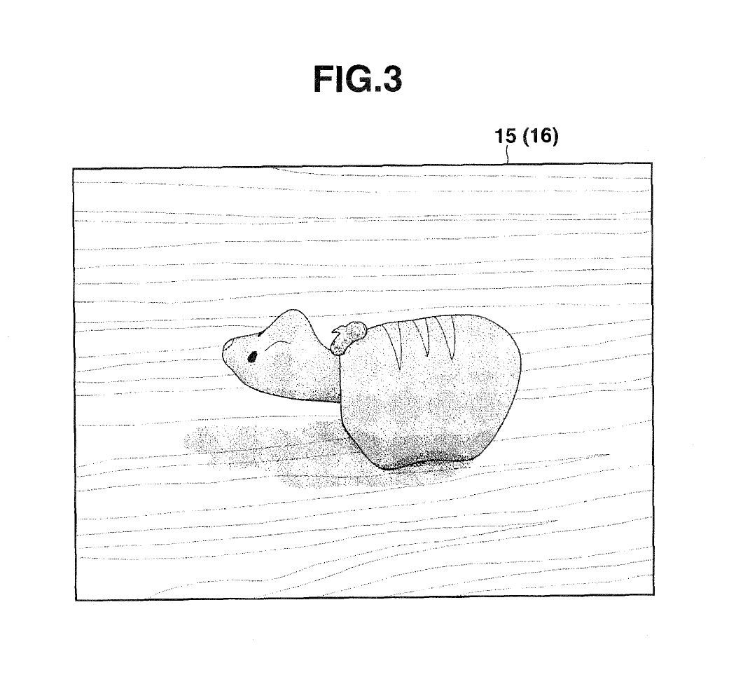

FIG. 3 illustrates an example of the image data, which is selected by the user in step S102 and displayed on the display 15. FIG. 3 illustrates a captured image of an “akabeko (red cow)”, which is of a local traditional toy of Aizu district of Fukushima prefecture (Japan) and placed on a wooden plate.

In step S103, it is assumed that the drawing style of “color pencil” is selected as the image in FIG. 3, and it is assumed that “canvas”, “scale”, “material”, “style”, “color”, “deform”, and “focus” is selected as various parameters associated with the drawing style of “color pencil”. The parameters are selected by way of example. As described above, actually many parameters exist in order to express the drawing style of “color pencil”.

The CPU 11 performs the image transformation according to the set drawing style and the various parameters associated with the drawing style (step S104). Based on the transformed image data, the CPU 11 performs the display using the whole surface of the display 15 (step S105).

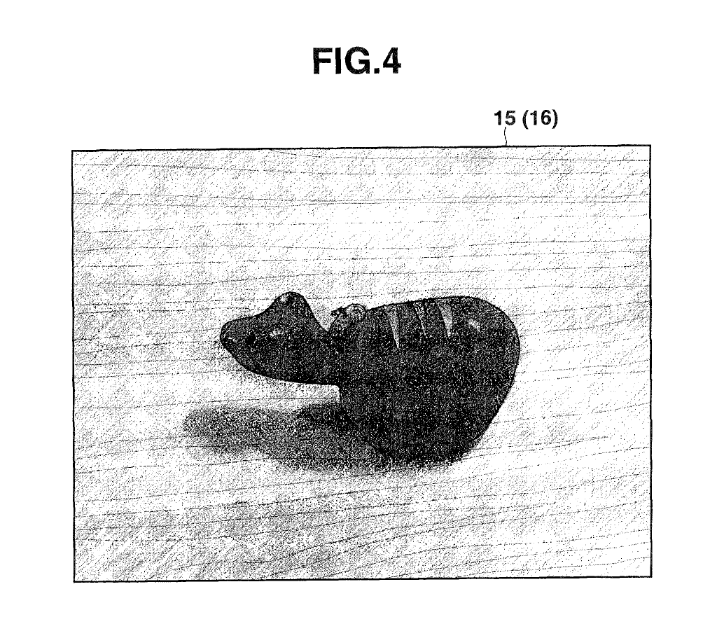

FIG. 4 illustrates a result in which the image transformation is performed to the image in FIG. 3 by the drawing style of “color pencil”. The sketch-style image in which the whole of the image is constructed by diagonally right up lines is obtained as illustrated in FIG. 4.

After displaying the transformed image on the display 15, the CPU 11 compresses and files the transformed image based on, for example, the JPEG data format (step S106).

The transformed image data file is associated with the contents of the drawing style used in the image transformation and various pieces of parameter information associated with the image transformation by including the contents of the drawing style and the various pieces of parameter information in part of metadata of imaging data such as an imaging date and time and an imaging condition of the image. The transformed image data file associated with the contents of the drawing style and the various pieces of parameter information is newly written and stored in the transformed image database 13D (step S107). The string of pieces of processing in FIG. 2 is temporarily ended.

Then, processing of touching up the image to which the image transformation is already performed will be described.

In FIG. 2, when the user performs a selection operation to touch up the transformed image data to which the image transformation is already performed in step S101, the CPU 11 determines that the user performs the selection operation, and encourages the user to set one of the pieces of transformed image data, which are stored in the transformed image database 13D of the storage 13 while the image transformation is already performed.

At this point, for example, the CPU 11 reads the thumbnail images or pieces of data of resized images of the original pieces of image data 13D1, 13D2, . . . stored in the transformed image database 13D, displays a list of the thumbnail images or pieces of data of resized images, and receives the user operation to select one of the original pieces of image data 13D1, 13D2, . . . from the touch panel 16 or the key operation unit 14A (step S108).

As needed basis, the CPU 11 may perform the display control such that the user can check the contents of the images by enlarging only the temporarily-selected image using the whole or most part of the display 15.

In the embodiment, one of the pieces of transformed image, which is stored in the transformed image database 13D while the image transformation is already performed, is selected. Alternatively, for example, the pieces of processing from step S108 may be performed to one mail-attached transformed image, which is transmitted from a friend and includes attribute information while the image transformation is already performed.

When the transformed image is selected, the CPU 11 reads the string of various pieces of parameter information, which is stored while associated with the image data, and sets the parameters and the like in preparation for the drawing of the user (step S109).

The CPU 11 displays the transformed image selected again using the whole surface of the display 15 (step S110). Then, the CPU 11 determines whether the user performs the touch input operation using the touch panel 16 (step S111), determines whether the user performs a predetermined key operation to assign a color change of the image to be touched up using the key operation unit 14A (step S114), and determines whether the user performs a predetermined key operation to end the touch up using the key operation unit 14A (step S116). The CPU 11 repeatedly performs the pieces of processing in steps S111, S114, and S116 until the user performs each input operation.

As to a key assigning the color change and a key ending the touch-up, for example, a corresponding key name is displayed in an end portion of the image displayed on the display 15 as a guide message such as “color change”→“C” key/“end”→“E” key, and whether the corresponding key input is performed from the key operation unit 14A is determined.

When the user performs the touch input operation using the touch panel 16 (Yes in step S111), the CPU 11 detects a position coordinate sequence of the touch input operation (step S112). Then, the CPU 11 performs the image transformation to the drawing of the detected position coordinate sequence based on the parameter set in step S109, and overwrites the image displayed on the display 15 (step S113). Then, the flow goes to step S114.

At this point, the CPU 11 retains and manages the image data of the touched-up portion as another piece of layer data different from the pre-touch-up original image data. Therefore, even part of the original image data is not lost by the overwrite processing until the touch-up is ended, but the touched-up portion can easily be canceled as needed basis.

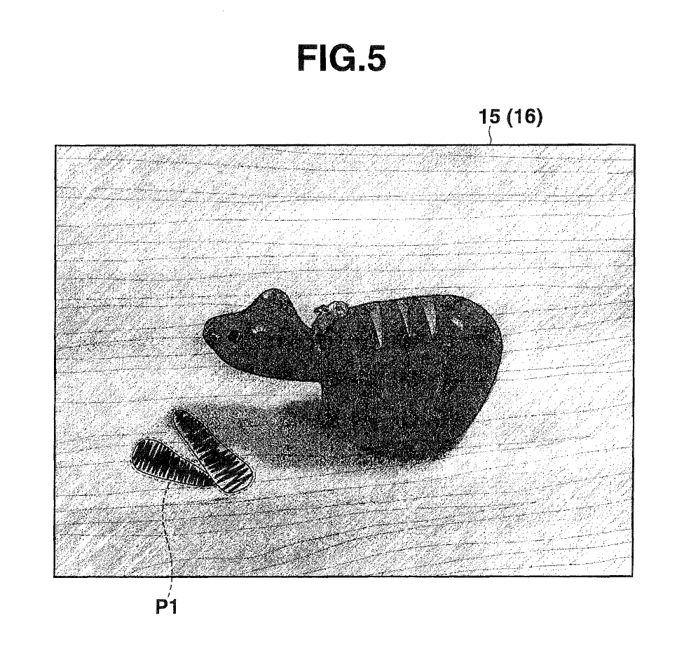

FIG. 5 illustrates a state in which the user manually draws a “carrot” within a portion P1 in the lower left portion of the image after the image in FIG. 4 is selected as a touch-up target and displayed on the display 15.

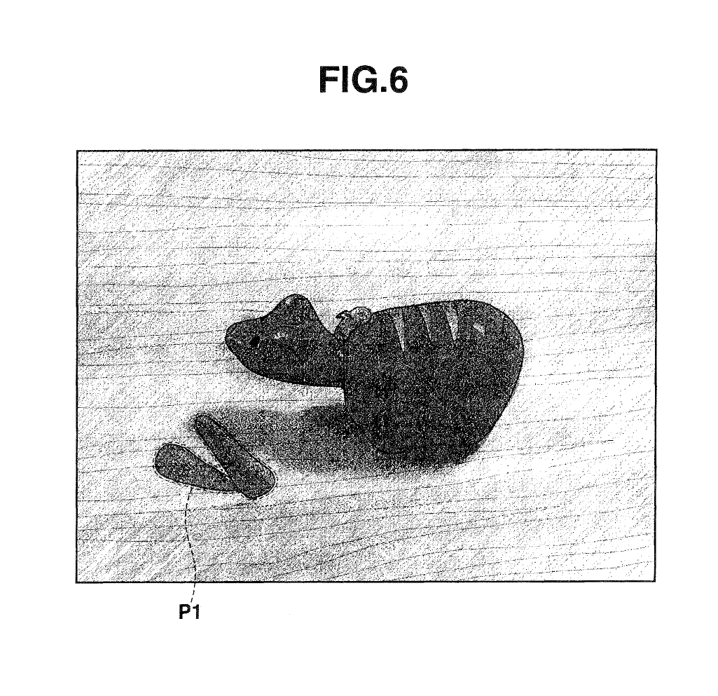

FIG. 6 illustrates a result obtained by performing the image transformation to a portion touched up in step S113 when the touch-up is performed as illustrated in FIG. 5. As illustrated in FIG. 6, using the various parameters of the previously-set drawing style of “color pencil”, the portion added to the portion P1 by the user is overwritten on the original image and displayed after the image transformation. Therefore, the natural drawing image can partially be added without having a feeling of strangeness.

For the sake of convenience, in the description in FIGS. 5 and 6, the portion touched up by the user is illustrated as a certain amount of drawing line. In the actual data processing, the image processing is collectively performed to the plural continuous points according to the coordinate value sequence of the touch input operation at predetermined time intervals, for example, a unit of 0.1 [second] or in each stroke of the drawing. Therefore, the user can perform the touch-up as needed while feeling the user's finger or the stylus pen like the color pencil (or painting brush).

The image transformation may be performed to the touched-up image portion after the end of the touch-up is detected in step S116. In this case, until the user performs the key operation to end the touch-up, the drawing touched up by the user is displayed irrespective of the style of the around transformed image as illustrated in FIG. 5. When the user performs the key operation to end the touch-up, the image is updated to an image having the same style as the around transformed image as illustrated in FIG. 6.

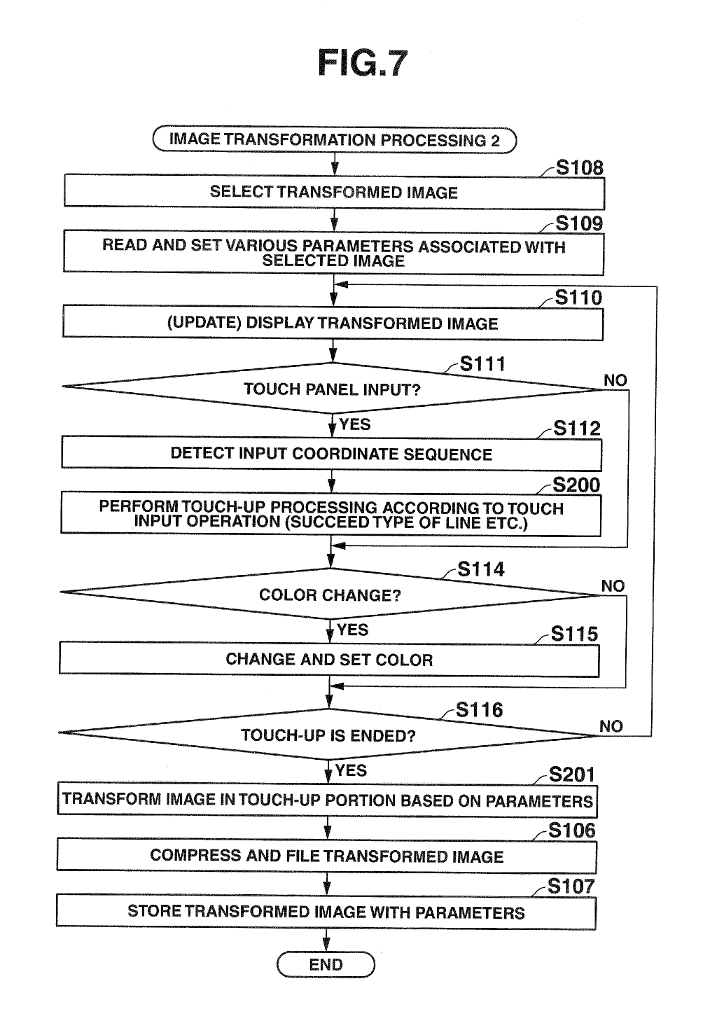

FIG. 7 is a flowchart illustrating an operation when the image transformation is performed to the touched-up image portion after the end of the touch-up is detected. The same step as that in FIG. 2 is designated by the same numeral, and the description is omitted.

In step S108, the transformed image to which the image transformation is already performed is selected. Then, the string of various pieces of parameter information on the selected transformed image data is read and set (step S109), and the transformed image is displayed (step S110).

When the user performs the touch input operation (Yes in step S111), the CPU 11 detects a position coordinate sequence of the touch input operation (step S112). Then, the CPU 11 performs touch-up processing according to the position coordinate sequence to which the touch input operation is performed using the touch panel input device 16 (step S200). In this case, it is assumed that the thickness or color of the line can arbitrarily be set like the painting software, and it is assumed that the thickness or color set at that time is succeeded.

When the user performs the predetermined key operation to end the touch up (Yes in step S116), the image transformation is collectively performed based on the parameters set with respect to the touched-up image portion P1 (step S201).

The following steps of processing are identical to those in FIG. 2. That is, the transformed image is compressed and filed (step S106), and the transformed image data file is associated with the contents of the drawing style and the various pieces of parameter information, and the transformed image data file is newly written and stored in the transformed image database 13D (step S107). The processing in FIG. 7 is ended.

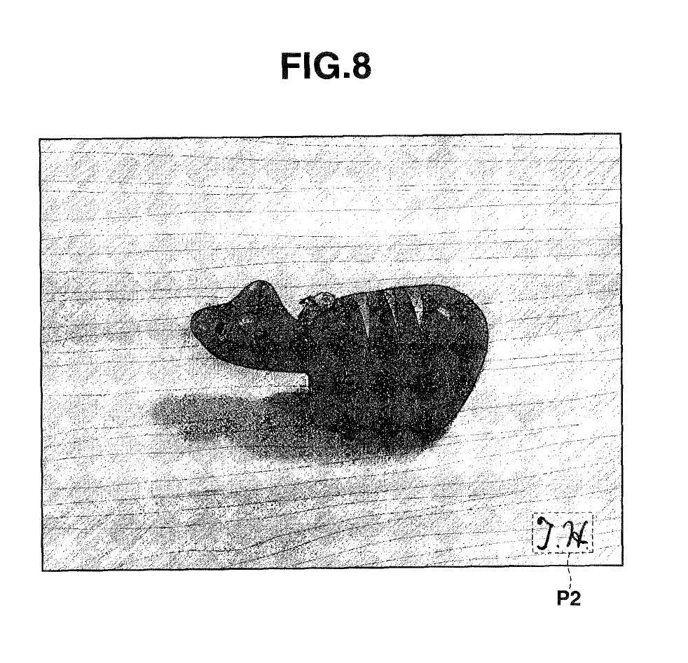

FIG. 8 illustrates a state in which the user manually draws a signature “T.H.” in touch-up writing to add within a portion P2 in the lower right portion of the image after the image in FIG. 4 is selected as the touch-up target and displayed on the display 15.

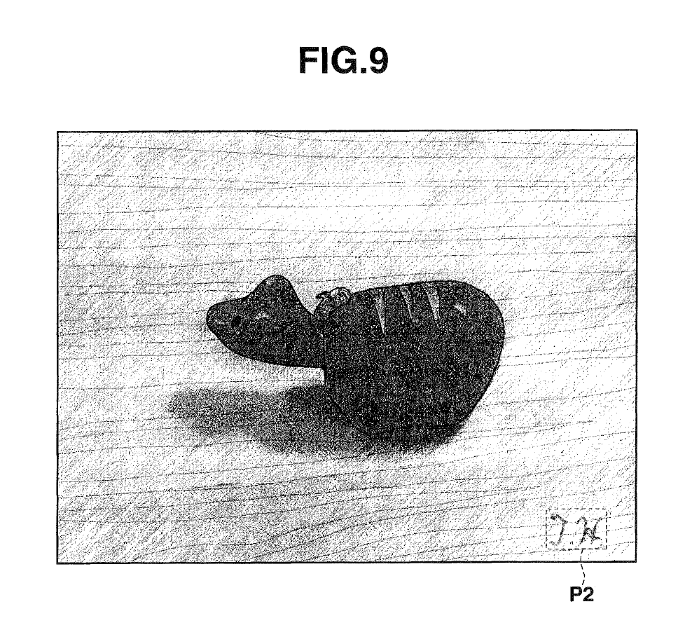

FIG. 9 illustrates a result obtained by performing the image transformation to a portion touched up in step S113 in FIG. 2 when the touch-up is performed as illustrated in FIG. 8. As illustrated in FIG. 9, using the various parameters of the previously-set drawing style of “color pencil”, the signature portion added to the portion P2 by the user is overwritten on the original image and displayed after the image transform. Therefore, the natural drawing image can partially be added without having the feeling of strangeness.

When the user performs the predetermined key operation to change the color of the image touched up using the key operation unit 14A (Yes in step S114), the CPU 11 changes and sets the color of the added line according to the selection of the user (step S115). Then, the flow goes to step S16.

When the user performs the predetermined key operation to end the touch-up using the key operation unit 14A (Yes in step S116), the CPU 11 overwrites the pieces of image data of all the touched-up portions, which are retained and managed as the layer different from the original image data at that time, on the original image data, and compresses and files the touched-up image data based on the JPEG data format (step S106).

The transformed image data file is associated with the contents of the drawing style read in step S109 and various pieces of parameter information associated with the image transformation by including the contents of the drawing style and the various pieces of parameter information in part of the metadata of imaging data such as an imaging date and time and an imaging condition of the image. The transformed image data file associated with the contents of the drawing style and the various pieces of parameter information is newly written and stored in the transformed image database 13D (step S107). The processing in FIG. 2 is temporarily ended.

In the embodiment, the touch-up processing is performed with respect to the handwriting drawing operation performed by the user using the touch panel 16. Alternatively, another piece of captured image data may partially be added.

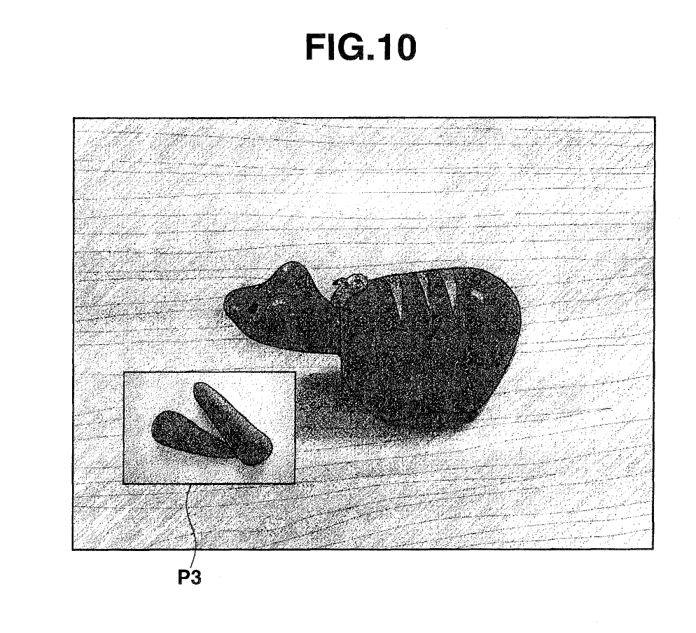

FIG. 10 illustrates a state in which the user reads and overwrites to synthesize another image within a portion P3 in the lower left portion of the image after the transformed image in FIG. 4 is selected as the touch-up target and displayed on the display 15.

FIG. 10 illustrates a result obtained by the image transformation when the image synthesis is performed as illustrated in FIG. 9. As illustrated in FIG. 9, even in the portion P3 of the synthesized image, the image transform is performed with the same style as the outside of the portion P3. Therefore, the feeling of strangeness still exists because the original color is different in the surrounding portion. However, the user performs the touch-up while assigning the color similar to that of the surrounding, which allows the synthesized image to fit in to an extent that the difference is eliminated.

As described above, according to the embodiment, when the image is further added to the transformed image to which the image transformation is performed as one of the image transforms, the feeling of strangeness can be reduced as much as possible by utilizing the original parameter information and the like.

In the embodiment, for example, the thickness of the drawing style corresponding to the thickness of “line” can be set as a part of the image transform parameters in “color pencil”, and the image is updated in consideration of the thickness of the style when the image of the touched-up portion is updated. Therefore, the natural drawing can be obtained while the difference between the touched-up portion and the surrounding portion is reduced as much as possible.

In the embodiment, the color can be set as a part of the image transform parameters, and the image is updated in consideration of the color when the image of the touched-up portion is updated. Therefore, the natural drawing can be obtained while the difference between the touched-up portion and the surrounding portion is reduced as much as possible.

In the embodiment, according to the image transformation program 13A stored in the storage 13, which performs the image transformation to the image data stored in the image database 13C, the image transformation is also performed to the touched-up portion of the image data stored in the transformed image database 13D using the same parameters. Therefore, because not only the parameters used but also the image transformation are common, compatibility between the images are enhanced, and the image transformation associated with the natural touch-up can be performed without having the feeling of strangeness.

Although the invention is used as the image processing apparatus in the embodiment, the invention is not limited to the image processing apparatus. For example, the invention can be implemented in various modes such as application software that performs the same image transformation on a personal computer, an image transformation function that is previously and fixedly installed in a digital camera, and image transformation service that is provided on the Web server that can be connected through the Internet In the embodiment, the touch panel is used in the touch-up. Alternatively, a mouse or a keyboard may be used.

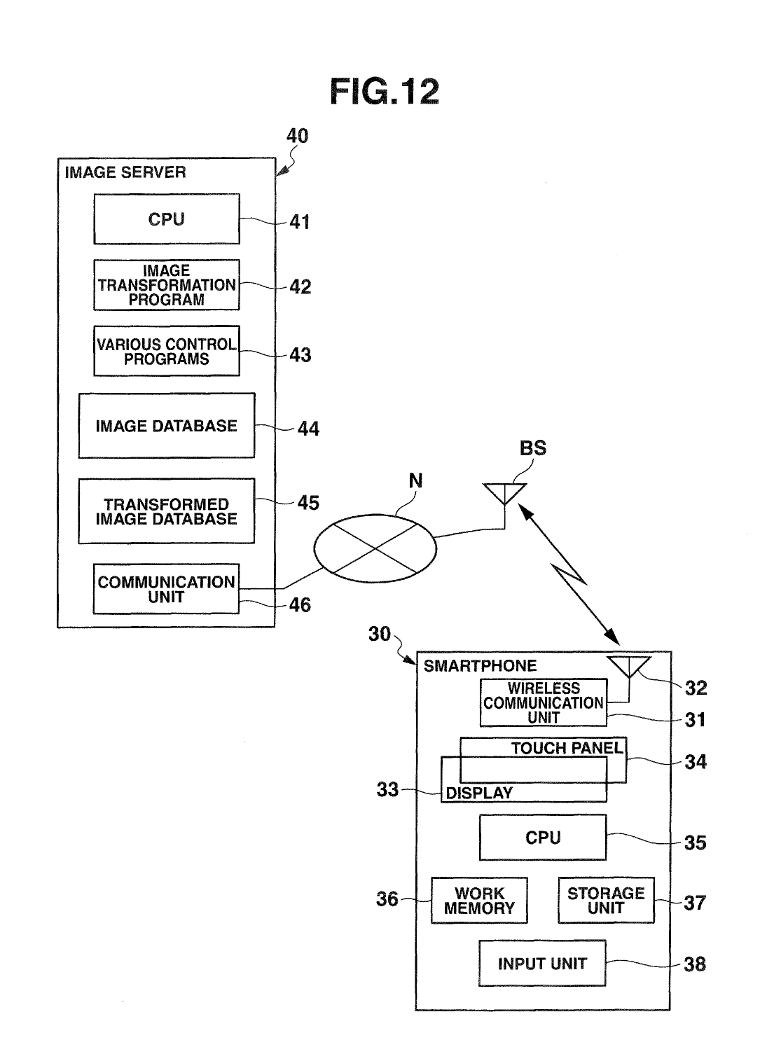

FIG. 12 illustrates a schematic configuration of an entire system when the image transformation service that is provided on the Web server that can be connected through the Internet is utilized by a smartphone that is of a terminal. In FIG. 12, a smartphone 30 is connected to an image server 40 through a nearest base station BS and the Internet N.

The smartphone 30 includes a wireless communication unit 31, a wireless antenna 32, a display 33, a touch panel 34, a CPU 35, a work memory 36, a storage 37, and an input device 38.

The wireless communication unit 31 wirelessly transmits and receives data to and from the nearest base station BS through the wireless antenna 32 according to, for example, an IMT-2000 standard. The display 33 is constructed by a color liquid crystal panel that covers the substantially whole surface on the chassis front surface side of the smartphone 30. The touch panel 34 in which the transparent electrode is used is integrally provided in the display 33.

The CPU 35 controls the whole operation of the smartphone 30, and the work memory 36 and the storage 37 are connected to the CPU 35. Various control programs including an image transformation program, various pieces of stylized data, and image data are stored in the storage 37.

The input device 38 includes a key operation unit that is provided in a side surface of the chassis of the smartphone 30 and a touch panel controller that detects a coordinate of the touch operation position on the touch panel 34.

The image server 40 includes a CPU 41, an image transformation program storage 42, a control program storage 43, an image database (DB) 44, a transformed image database (DB) 45, and a communication unit 46.

The CPU 41 controls the whole operation of the image server 40 using programs and the like, which are stored in the image transformation program storage 42 and control program storage 43.

The original image data to which the image transformation is not performed yet is stored in the image database 44 similarly to the image database 13C in FIG. 1. Similarly to the transformed image database 13D in FIG. 1, the transformed image data to which the image transformation is already performed is stored in the transformed image database 45 while associated with the parameter information. The communication unit 46 transmits data to and receives data from various devices that access the image server 40 through the Internet N.

In the configuration in FIG. 12, the case that the image data stored in the transformed image database 45 of the image server 40 is downloaded to the smartphone 30 will briefly be described.

As described above, the parameter information is associated with the image data downloaded to the smartphone 30. On the side of the smartphone 30, the downloaded image data is temporarily stored in the storage 37, and the image data is set to the work memory 36 and displayed on the display 33.

When the user performs the write operation using the touch panel 34, the CPU 35 transmits the data sequence of the written position coordinate to the image server 40 in each time. The image server 40 performs the image transformation using the corresponding parameter information according to contents of the user operation transmitted from the image server 40, updates and stores the image by partially overwriting the image, and sends back the updated image data to the smartphone 30.

The smartphone 30 receives the sent-back image data and displays the image data on the display 33, which allows the user to check the written contents.

When a predetermined instruction operation is performed after the write of the user, an instruction signal is transmitted from the smartphone 30 to the image server 40. The image server 40 that receives the instruction signal files the image data, which is updated and stored at that time, as another piece of image data again while the parameter information is associated with the image data, and additionally stores the image data in the transformed image database 45.

At this point, independently of the data stored on the side of the image server 40, the smartphone 30 may finally file the data transmitted from the image server 40 and stores the data in the storage 37 as needed basis.

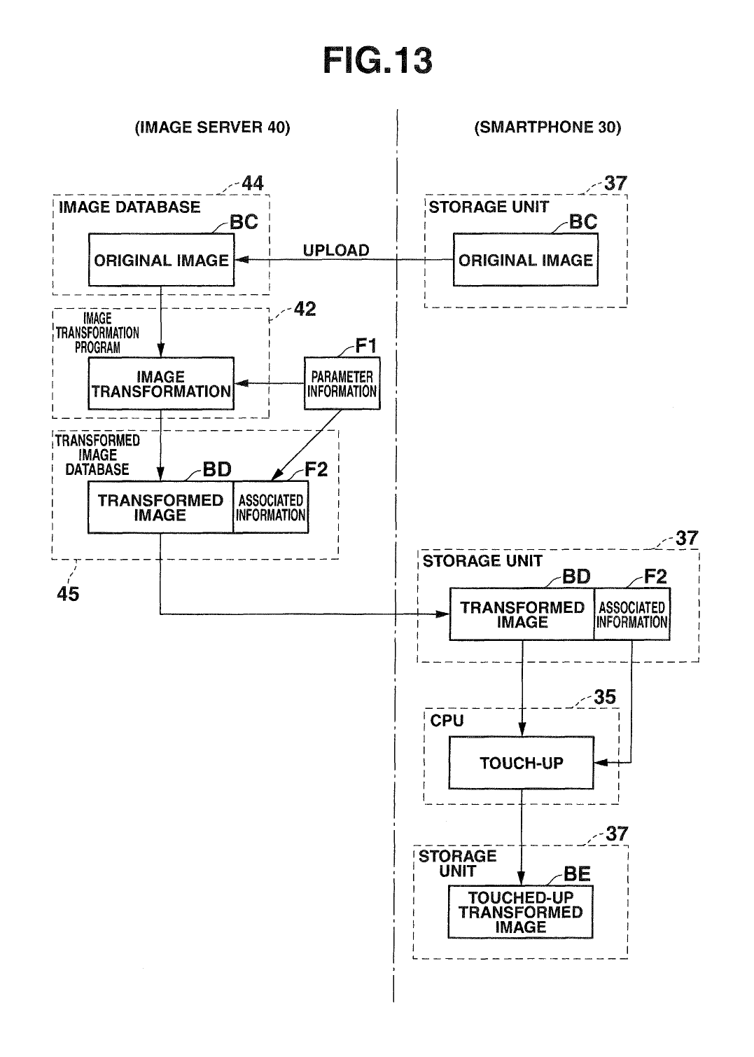

FIG. 13 is a functional block diagram illustrating an image transformation in the system configuration.

An original image BC stored in the storage 37 of the smartphone 30 is uploaded on the image database 44 of the image server 40. Based on parameter information F1, the image transformation is performed using the image transformation program 42, and a transformed image BD to which the image transformation is performed is obtained.

The transformed image RD is stored in the transformed image database 45 while the parameter information F1 used in the image transformation is used as attribute information F2. Although the parameter information F1 may be identical to the attribute information F2, only the minimum information may be used as the attribute information F2 because the parameter information F1 is a large amount of information.

Both the transformed image BD and the attribute information F2 are transmitted to the smartphone 30, and stored in the storage 37. The CPU 35 of the smartphone 30 performs the same steps of processing as those in steps S111, S112, S200, S114, S115, S116, and S201 in FIG. 7.

An image BE that is touched up with the same style as the original transformed image BD using the display 33 and touch panel 34 of the smartphone 30 is stored in the storage 37.

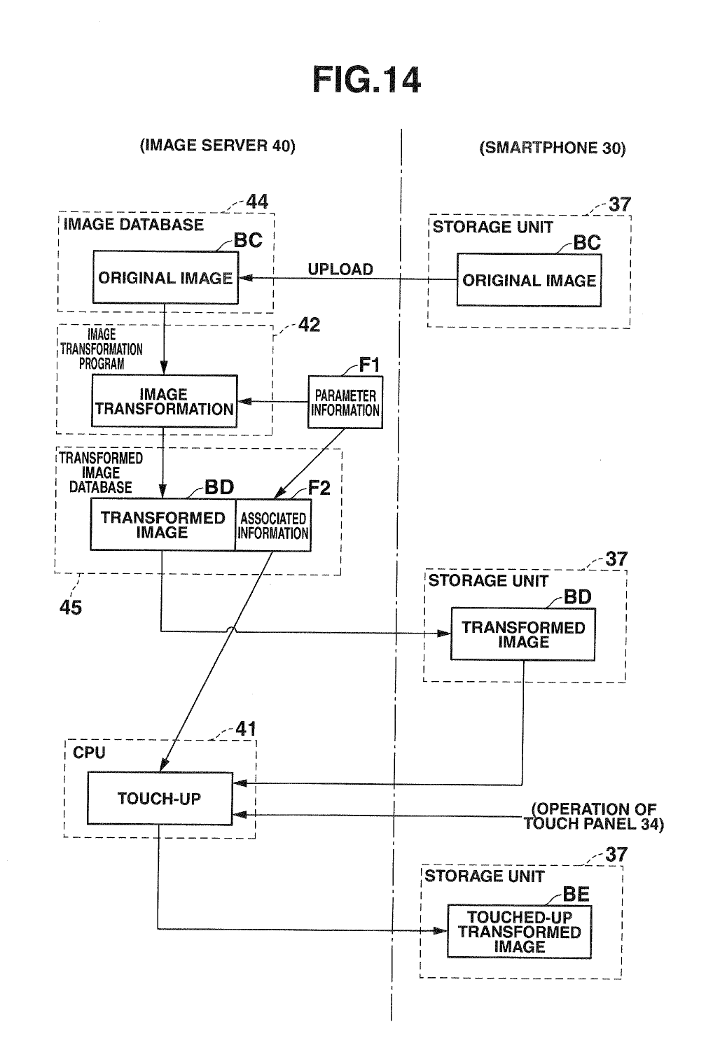

Another modification will be described with reference to FIG. 14. The attribute information F2 is stored in the transformed image database 45 while associated with the transformed image BD. Only the transformed image BD is transmitted to the smartphone 30, but the attribute information F2 is not transmitted to the smartphone 30.

When the transformed image BD is touched up, the transformed image BD is transmitted to the image server 40, and the update is performed based on the attribute information F2 associated with the transformed image BD. At this point, the touch-up operation is performed using the display 33 and touch panel 34 of the smartphone 30. Therefore, an amount of information transmitted to the smartphone 30 can be reduced, and it is not necessary to manage the attribute information F2 in the smartphone 30.

When the attribute information F2 is stored in a later process while associated with the transformed image BD, the transformed image can be deleted from the image database 44 at a stage at which the transformed image BD is downloaded to the smartphone 30.

Because the number of transformed images becomes huge when many users use the system, when the original transformed image can be identified from the attribute information at later time when the correction is needed, it is not necessary that the transformed image having the large data amount be retained in the transformed image database 45 of the image server 40.

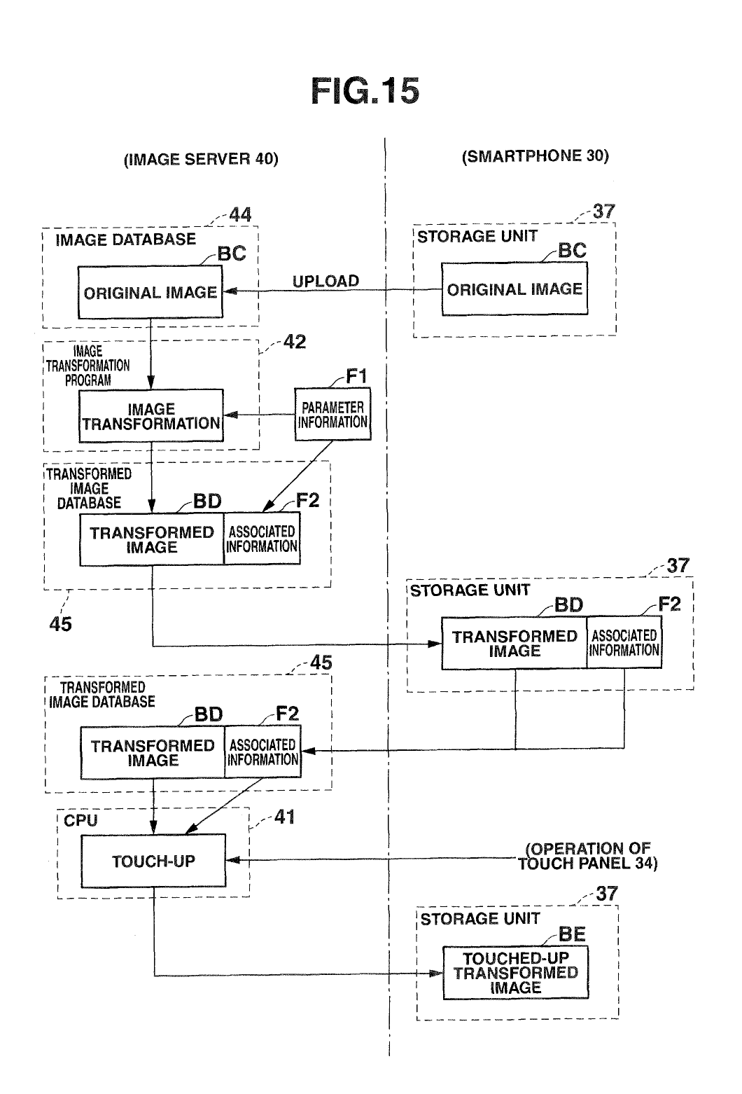

Still another modification will be described with reference to FIG. 15. Although the attribute information F2 is stored in the transformed image database 45 while associated with the transformed image BD, both the transformed image DB and the attribute information F2 are transmitted to the smartphone 30. The tone can be updated in the smartphone 30 when an image transformation engine is mounted on the smartphone 30. Otherwise the transformed image DR and the attribute information F2 are returned to the image server 40, and the image server 40 performs the touch-up processing based on the attribute information F2. In this case, because the attribute information and the transformed image are temporarily transmitted to the smartphone 30, it is not necessary to manage the attribute information on the side of the image server 40.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, the present invention can be practiced as a computer readable recording medium in which a program for allowing the computer to function as predetermined means, allowing the computer to realize a predetermined function, or allowing the computer to conduct predetermined means.

What is claimed is:

1. An image processing apparatus comprising:
a storage configured to store a transformed image and attribute information indicating content of the image transformation;
a display controller configured to read and to display the transformed image stored in the storage;
a processor configured to process an image in an arbitrary portion in the image displayed by the display controller; and
an image update module configured to update the image in the portion, which is processed by the processor, according to the attribute information stored in the storage.

2. The image processing apparatus according to claim 1, further comprising a position specifying module configured to specify an arbitrary position on the image displayed by the display controller, and
wherein the processor is configured to process the image in a portion including the position specified by the position specifying module.

3. The image processing apparatus according to claim 1, further comprising a thickness specifying module configured to specify a thickness of drawing style that processes the image, and
wherein the image update module is configured to update an image, which includes the position specified by the position specifying module, in a portion of the thickness specified by the thickness specifying module in the image displayed by the display controller according to the attribute information stored in the storage.

4. The image processing apparatus according to claim 1, further comprising a color specifying module configured to specify a color that updates the image, and
wherein the image update module is configured to update an image of a portion including the position specified by the position specifying module in the image displayed by the display controller according to the attribute information stored in the storage using the color specified by the color specifying module.

5. The image processing apparatus according to claim 2, wherein
the position specifying module is configured to specify points on the image, and
the image update module is configured to update an image of a portion including the points specified by the position specifying module on the image according to the attribute information stored in the storage.

6. The image processing apparatus according to claim 1, wherein the image update module is configured to update the image in each predetermined time.

7. The image processing apparatus according to claim 1, further comprising an image transformation module configured to perform the image transformation to an original image, and
wherein the transformed image obtained by the image transformation module is stored in the storage while attribute information indicating a content of the image transformation is associated with the transformed image, and
the image update module is configured to update the transformed image obtained by the image transformation module according to the attribute information stored in the storage.

8. The image processing apparatus according to claim 1, wherein
the image update module is configured to store an updated image content as a layer different from a layer of the transformed image that the display controller reads from the storage, and
the display controller is configured to display the updated content.

9. An image processing method comprising:
storing a transformed image and attribute information indicating a content of the image transformation into a storage;
reading and displaying the stored transformed image stored in the storage;
processing an image in an arbitrary portion in the displayed image; and
updating the processes image in the portion according to the attribute information stored in the storage.

10. An image processing system comprising a terminal and a server which are connectable through a network,
wherein the server comprises:
a receiver configured to receive an original image from the terminal;
an image transformation module configured to obtain a transformed image by performing an image transformation to the original image received by the receiver;
a storage configured to store the transformed image and attribute information indicating a content of the image transformation; and
a transmitter configured to transmit the transformed image stored in the storage and the attribute information to the terminal, and
wherein the terminal comprises:
a receiver configured to receive the transformed image transmitted from the server;
a display controller configured to display the transformed image received by the receiver of the terminal;
a position specifying module configured to specify a position on the transformed image displayed by the display controller;
a processor configured to process an image of a portion, which includes the position specified by the position specifying module, in the transformed image displayed by the display controller; and
an image update module configured to update the image processed by the processor based on the attribute information.

11. An image processing system comprising a terminal and a server which are connectable through a network,
wherein the server comprises:
a receiver configured to receive an original image from the terminal;
an image transformation module configured to obtain a transformed image by performing an image transformation to the original image received by the receiver;
a storage configured to store the transformed image obtained by the image transformation module and attribute information indicating a content of the image transformation;
a transmitter configured to transmit the transformed image stored in the storage to the terminal; and
an image update module configured to update the processed transformed image transmitted from the terminal based on the attribute information,
wherein the terminal comprises:
a receiver configured to receive the transformed image transmitted from the server;
a display controller configured to display the transformed image received by the receiver of the terminal;
a position specifying module configured to specify a position on the transformed image displayed by the display controller;
an image processor configured to process an image of a portion, which includes the position specified by the position specifying module, in the image displayed by the display controller; and
a transmitter configured to transmit the transformed image processed by the image processor to the server,
wherein the server is configured to transmit the image updated by the image update module to the terminal, and
wherein the terminal is configured to receive the updated image, and to cause the display controller to display the updated image.

12. The image processing system according to claim 11, wherein the transformed image obtained by the image transformation module is stored in the storage of the server while associated with the attribute information indicating the content of the image transformation.

13. The image processing system according to claim 12, wherein the storage of the server is configured to delete the transformed image obtained by the image transformation module after the transmitter of the server transmits the transformed image to the terminal.

14. An image processing system comprising a terminal and a server which are connectable through a network,
wherein the server comprises:
a receiver configured to receive an original image from the terminal;
an image transformation module configured to obtain a transformed image by performing an image transformation to the original image received by the receiver;
a storage configured to store the transformed image and attribute information indicating a content of the image transformation; and
a transmitter configured to transmit the transformed image stored in the storage and the attribute information to the terminal,
wherein the terminal comprises:
a display controller configured to display the transformed image received from the server;
a position specifying module configured to specify a position on the transformed image displayed by the display controller;
a processor configured to process an image of a portion, which includes the position specified by the position specifying module, in the transformed image displayed by the display controller; and
a transmitter configured to transmit the image, in which the image portion is processed by the image processor, and the attribute information to the server, and
wherein, the server is configured to update the content stored in the storage using the transformed image, which is obtained such that the image transformation module performs the image transformation to the image processed by the terminal based on the attribute information transmitted from the terminal.

15. A non-transitory computer-readable storage medium having stored thereon a computer program which is executable by a computer, the computer program comprising instructions capable of causing the computer to execute functions of:
storing a transformed image and attribute information indicating a content of the image transformation into a storage;
reading and displaying the transformed image stored in the storage;
processing an image in an arbitrary portion in the displayed image; and
updating the processes image in the portion according to the attribute information stored in the storage.

16. A non-transitory computer-readable storage medium having stored thereon a computer program which is executable by a computer in a terminal connectable to a server through a network, the computer program comprising instructions capable of causing the computer to execute functions of:
transmitting an original image to the server;
specifying a tone of image for which the original image is to be transformed;
displaying the transformed image of the specified tone;
specifying a position on the displayed transformed image;
processing the displayed transformed image in a portion including the specified position; and
updating the processed image with a predetermined condition.
